(19) United States
(12) Patent Application Publication
(10) Pub. No.: US 2002/0188700 A1
(43) Pub. Date: Dec. 12, 2002

(54) System and method of interactive network system design

(76) Inventors: Todd Steitle, Plano, TX (US); Paul Eaklor, Colorado Springs, CO (US)

Correspondence Address: BELL, BOYD & LLOYD, LLC, PO BOX 1135, CHICAGO, IL, 60690-1135, US

(21) Appl. No.: 09/877,626

(22) Filed: Jun. 8, 2001

(51) Int. Cl. G06F 15/177

(52) U.S. Cl. 709/220

(57) ABSTRACT

A network system design system including a first computing device, a second computing device, and an executing program. The second computing device is communicably coupled to the first computing device. The executing program is running on the overall computing device comprising the first computing device and the second computing device. Therein the executing program is adapted to configure a network system.

### FIELD

The present invention has emerged from the field of network system design technology.

### BACKGROUND

Design of a network system has always required consideration of customer needs, available network system components, and other factors.

Typically, the process of designing a network system has been slowed by the fact that typically a customer has been unable to exercise significant control and initiative over the design function. This stems from the fact that such control has required a fairly advanced level of technical expertise in the area of network systems. The technical expertise of customers in the network system area has typically been significantly less than that possessed by their network system vendor.

In view of the foregoing, it would be highly desirable to make available a network design process or system that incorporates the feature of allowing the user to configure a network system powerfully but with minimal requirement for detailed technical knowledge on the part of the user. In addition, it would be highly desirable to make available a network design process or system that incorporates the feature of allowing such design to occur across a network connection.

### SUMMARY

Generally, the preferred embodiment allows a user to design, via a network connection, a network system without requiring the user to have a detailed technical knowledge of the network system technology. The preferred embodiment allows the user to initiate control of the process.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a diagrammatic view illustrating a conceptualization of an exemplary embodiment of the invention.

FIG. 2 is a diagrammatic view illustrating the process flow of an exemplary embodiment of the invention, from the perspective of the vendor computing device.

FIG. 3 is a diagrammatic view illustrating the graphical output of an exemplary embodiment of the invention.

FIG. 4 is a diagrammatic view illustrating another graphical output of an exemplary embodiment of the invention.

### DETAILED DESCRIPTION

In the following detailed description of the preferred embodiments, reference is made to the accompanying drawings which form a part hereof, and in which is shown by way of illustration specific preferred embodiments in which the present invention may be practiced. These embodiments are described in sufficient detail to enable those skilled in the art to practice the present invention, and it is to be understood that other embodiments may be utilized and that logical, mechanical and electrical changes may be made without departing from the spirit or scope of the present invention. To avoid detail not necessary to enable those skilled in the art to practice the present invention, the description may omit certain information known to those skilled in the art. The following detailed description is, therefore, not to be taken in a limiting sense, and the scope of the present invention is defined only by the appended claims.

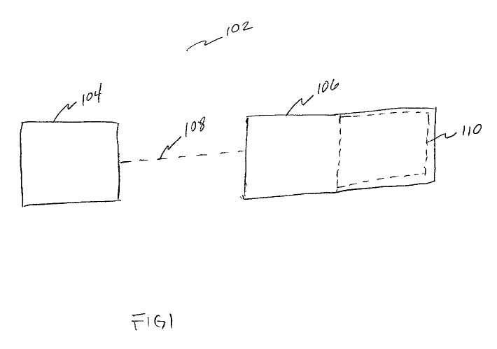

Network system design system 102, FIG. 1, includes a first computing device 104 and second computing device 106. First computing device 104 is communicably coupled to second computing device 106 via a network connection 108. Executing program 110 is running on second computing device 106. Note that the executing device 110 could be running alternatively on first computing device 104 or also alternatively on a combination of first computing device 104 and second computing device 106. The executing program 110 is adapted to configure a network system. Also note that network connection 108 may be wireless or wireline or any other technology for communicable coupling.

Herein, configuring a network should be understood to include selecting network components to compose a network and defining the relationships among the components. Examples of components include types of network servers, types of software, types of routers, types of client workstations, etc.

For example, first a specific type of network server might be selected to be part of the network. Then a specific type of software might be selected to run on the network server. Then several specific types of routers might be selected. Then additional network components might be selected until the network system is configured.

In the preferred embodiment, network connection 108 constitutes an internet connection, and executing program 1110 comprises a web server. The web server is scalable. Possible states of the web server include a single system, multiple systems wherein the multiple systems are related by clustering, or multiple systems related by clustering wherein the loads of the multiple systems are balanced by geographic load balancing. Similarly, the network system designed by the network system design system 102 is scalable. Possible states of the network system include a single system, multiple clustered systems, and multiple clustered systems with load balanced by geographic load balancing.

In the preferred embodiment, the executing program 110 is adapted to interface with a billing system. The executing program 110 sends information to the billing system to allow billing automation. Similarly, executing program 110 may be interfaced with other software such that executing program 110 sends information to that software in a format useable by that software.

In the preferred embodiment executing program 110 is adapted to show one of multiple views through the first computing device 104. Each view is differentiated by the information displayed whether such differences are textual, graphical or both and also differentiated by access rights to change information. Views include customer view, sales person view, and management view. Other views are easily addable. In the preferred embodiment executing program 110 includes also a database server for accessing data elements related to the network system being configured. In the preferred embodiment some of these data elements include available components, business rules, graphic representation data, component prices, components in inventory and component functionalities. The business rules would include for example combinations of available components as being favored or disfavored. Disfavored combinations would be those combinations of components which while technically allowed to be combined according to the component manufacturer guidelines, are known to be poorly interactive.

In the preferred embodiment executing program 110 composes the data elements into a unified front end such that a viewer would not be made aware of the fact that each data element may come from a separate source. In the preferred embodiment the graphic representation data comprises bit maps. Configuration of the network system design system 102 would include in addition to selection and assembly of components, software configuration, security configuration and storage configuration among other aspects. The software would be adapted to operate the network system. The security as configured would secure the network system, and the storage would store data for the network system.

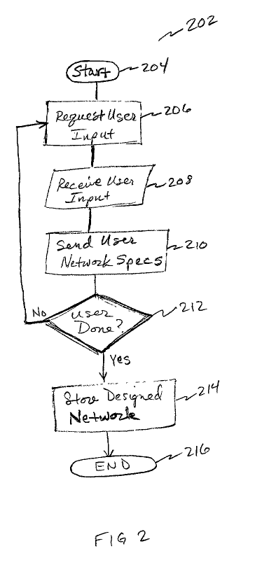

Network system design method 202, FIG. 2, shows the process flow for a method of designing a network system. Process flow originates in block 204 from block 204, the process flows to block 206. In block 206, user input is requested. The process then flows to block 208 and in block 208, user input is received. The user input in block 206 and block 208 may include many alternatives. Some alternatives for the user input of block 206 and block 208 might be a selected component, a selected component location, a connectivity between the selected component and previously selected components, a software option, a selected security, a storage option, a cluster configuration of the selected component, a geographic location of the selected component from block 208 the process flows to block 210.

In block 210 the user is sent network specifications at the given time. Examples of network specification information include graphical representation of components as configured to compose a network system, inventory levels, a selected component location, a connectivity between the selected component and previously selected components, a software option and a security option. Inventory levels in this case allow predication of lead times. From block 210 process flows to block 212, block 212 is a decision point. If the user indicates that the network system is finished being designed then flow passes to flow 214; otherwise, flow passes to block 206. In block 214 the network system as designed is stored from block 214 flow passes to block 216, block 216 terminates process 202.

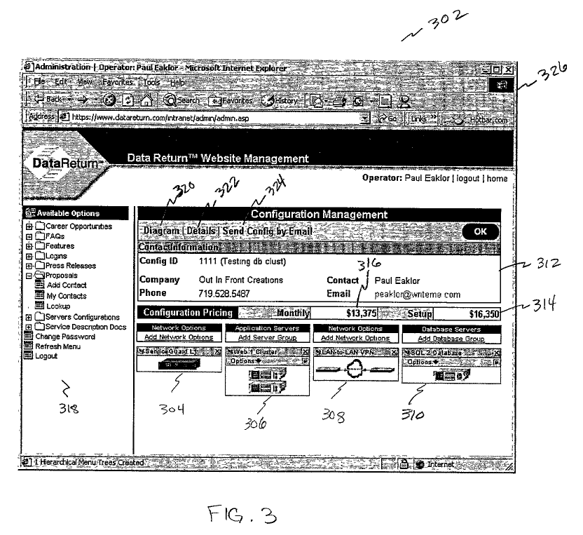

Screen capture 302, FIG. 3, shows a sample of the preferred embodiment's Graphical User Interface (GUI). Network option 304, application server 306, network option 308, database server 310 are all components that have been selected to be part of the network system being designed a window 312 displays configuration management information. Menu item 320 may be selected to see a graphical representation of the network system as a whole including components as well as connections between components. Menu item 322 may be selected in order to see more textual details about the textual system as designed thus far. Menu item 324 may be selected to send the current configuration information by e-mail.

Set up fee 314 indicates a cost calculated by the program as the initial set up fee necessary to be paid to initiate billed out of the network system per the network system as designed thus far. Currency amount 316 indicates a monthly charge calculated similarly to the set up fee. Menu tree 318 indicates many different views which are possible through the software. Web browser 326 is used as a convenient way of accessing the information served from the computing device on which the network device software is running.

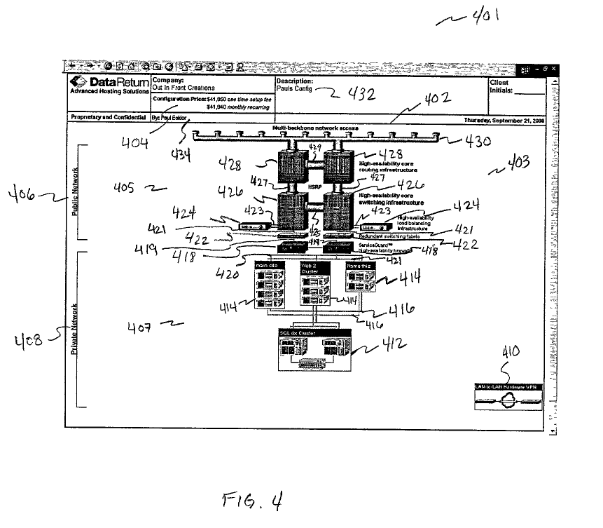

Screen capture 401, FIG. 4, shows another sample of the preferred embodiment's GUI. Area 402 depicts a configured network 403. The current price of configured network 403 is displayed in area 404. In this case, the current price in area 404 includes a one time setup fee and a monthly recurring amount. Configured network 403 comprises a public network 406 and a private network 408. A LAN-to-LAN Hardware specification 410 is specified to be virtual private network (“VPN”). In this case, the VPN would comprise the use of encryption in the lower protocol layers of the Internet, which is otherwise insecure, to provide a secure connection.

Configured network 403 comprises a public network 405 and a private network 407. Public network 405 comprises that equipment on the side of the two firewalls 418 indicated by bracket 406. Private network 407 comprises that equipment on the side of two firewalls 418 indicated by bracket 408. Conceptually, the two firewalls 418 can be considered part of public network 405 and private network 407.

An SQL 4x cluster 412 begins the back end of private network 407. Three server arrays 414 are connected to SQL 4x cluster 412 by connections 416. The three server arrays 414 are connected to one of the two firewalls 418 by connection 420, and to the other of the two firewalls 418 by connection 421.

One of two redundant switching fabric devices 422 is connected to one of the two firewalls 418, and the other of the two redundant switching fabric devices 422 is connected to the other of the two firewalls 418, by connections 419. One of two high-availability core switching infrastructure devices 426 is connected to one of the two redundant switching fabric devices 422, and the other of the two high-availability core switching infrastructure devices 426 is connected to the other of the two redundant switching fabric devices 422, by connections 421.

One of two high-availability load balancing infrastructure devices 424 is connected to one of the two high-availability core switching infrastructure devices 426, and the other of the two high-availability load balancing infrastructure devices 424 is connected to the other of the two high-availability core switching infrastructure devices 426, by connections 423. The two high-availability core switching infrastructure devices 426 are connected to each other by connection 425.

One of two high-availability core routing infrastructure devices 428 is connected to one of the two high-availability core switching infrastructure devices 426, and the other of the two high-availability core routing infrastructure devices 428 is connected to the other of the two high-availability core switching infrastructure devices 426, by connections 427. The two high-availability core routing infrastructure devices 428 are connected to each other by connection 429.

In combination, the two firewalls 418, the two redundant switching fabric devices 422, the two high-availability load balancing infrastructure devices 424, the two high-availability core switching infrastructure devices 426, and the two high-availability core routing infrastructure devices 428 compose a hot swapable routing protocol to achieve high-availability. Connection 430 gives multi-backbone network access from the two high-availability core routing infrastructure devices 428. Area 432 depicts a description of the configured network 403, and area 434 depicts the author of the configured network 403.

The following guidelines indicate partial meanings of some terms as used herein, although none of these guidelines set forth the exclusive meaning of any term:

The term “network” refers to hardware and software data communication systems. Included in the meaning is a group of interconnected information handling systems such as computers and the communication channels which connect them.

The term “router” refers to a device that forwards packets between networks. The forwarding decision is based on network layer information and routing tables often constructed by routing protocols.

The term “internet” refers to any set of networks interconnected with routers. The term includes a network comprised of other networks.

The term “Internet” refers to the largest internet in the world. It is a three-level hierarchy composed of backbone networks, midlevel networks, and stub networks. These include commercial, university, and other research networks and military networks and span many different physical networks around the world with various protocols, chiefly the Internet Protocol.

The term “intranet” refers to any network which provides similar services within an organization to those provided by the Internet outside it but which is not necessarily connected to the Internet. May also be an internet or part of the Internet, for example. A common example is the use by a company of one or more web servers on an internal TCP/IP network for distribution of information within the company.

The term “extranet” refers to an intranet for which limited access has been granted to other organizations, the general public, or other entities other than the primary user of the intranet.

The term “communicably coupled” refers to any connection that is adapted to carry communication, whatever the supporting technology. It includes hard wire connections such as phone lines, T1 lines, DSL, fiber optic, etc. It also includes wireless connections adapted to carry communication such as via electromagnetic waves, wireless optics (e.g., infrared), etc. The technology by which the communication is transmitted is not material to the meaning of communicably coupled.

The term “computing device” includes a device having at least one central processing unit (CPU) and a memory device, wherein the CPU is adapted to process data that can be stored in the memory device before and/or after processing. Common examples of a computing device include personal computer, palm computing device, notebook computer, server, or mainframe. Also included within the definition of computing device is a system of multiple computers networked together such that processing and/or storage activities on the computers are coordinated. Also included in the definition of computing device is a system of devices networked together such that each device may not be a computer in its own right, but in combination, the networked devices achieve the functionality of a computer having at least one CPU and at least one memory device. For example, components of a computing device may be connected across the Internet.

The term “non-volatile storage” includes storage devices whose contents are preserved when their power is off. These devices are often used as secondary storage devices. Storage using magnetic media (e.g. magnetic disks, magnetic tape or bubble memory) is normally non-volatile by nature. Other examples of non-volatile storage include Bernoulli Box (trademark of Iomega Corporation), compact disc (CD), computer output on microfilm (COM), computer output on laser disk (COLD), digital audio tape (DAT), digital linear tape (DLT), digital versatile disk (DVD), electrically alterable programmable read-only memory (EAPROM), electrically erasable programmable read-only memory (EEPROM), erasable programmable read-only memory (EPROM), flash erasable programmable read-only memory (FEPROM), floppy disk, floptical, hard disk (removable or fixed), Jaz Drive (trademark of Iomega Corporation), JBOD, disk farm, magnetic disk, magnetic drum, optical disk, magneto-optical disk, one time programmable read-only memory (OTPROM or OTP), programmable read-only memory (PROM), tape drive, paper tape, and punch cards.

The term “volatile storage” includes storage devices whose contents are not ordinarily preserved when their power is off. Examples of volatile memory include semiconductor memories (static RAM and especially dynamic RAM), which are normally volatile but can be made into non-volatile storage by having a (rechargeable) battery or other uninterrupted power supply permanently connected. Dynamic RAM is particularly volatile since it loses its data, even if the power is still on, unless it is refreshed. An acoustic delay line is a (very old) example of a volatile storage device.

The term “memory device” includes all data storage devices, including non-volatile, volatile, and other data storage devices.

The term “executing program” includes program code and some private data. The program code may be shared with other executing programs that are executing the same program code but may include different private data. An executing program may include other associated resources such as a process identifier, open files, CPU time limits, shared memory, child processes, and signal handlers. A multitasking operating system can run multiple executing programs concurrently or in parallel.

The term “database” includes one or more large structured sets of persistent data, usually associated with software to update and query the data.

The term “query” includes a user's (or agent's) request for information, generally as a formal request to a database or search engine. SQL is the most common database query language.

The term “distributed query” includes a query issued against data of multiple databases, wherein at least one of the databases resides on one machine and at least one other of the databases resides on a different machine. A distributed query includes a query that selects data from multiple databases, using, for example, joins, nested queries, or views.

The terms “structured query language” and “SQL” are equivalent and include a language which provides a user interface to relational database management systems, developed by IBM in the 1970s for use in System R. SQL is the de facto standard, as well as being an ISO and ANSI standard. It is often embedded in other programming languages. The first SQL standard, in 1986, provided basic language constructs for defining and manipulating tables of data; a revision in 1989 added language extensions for referential integrity and generalized integrity constraints. Another revision in 1992 provided facilities for schema manipulation and data administration, as well as substantial enhancements for data definition and data manipulation. Development is currently underway to enhance SQL into a computationally complete language for the definition and management of persistent, complex objects. This includes: generalization and specialization hierarchies, multiple inheritance, user defined data types, triggers and assertions, support for knowledge based systems, recursive query expressions, and additional data administration tools. It also includes the specification of abstract data types (ADTs), object identifiers, methods, inheritance, polymorphism, encapsulation, and all of the other facilities normally associated with object data management.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provision of 35 U.S.C. §112, ¶6.

Although the present invention has been described with a certain degree of particularity, it should be recognized that elements thereof may be altered by persons skilled in the art without departing from the spirit and scope of the present invention. The present invention is limited only by the following claims and their equivalents.

What is claimed is:

1. A network system design system comprising:
(a) a combined computing device comprising:
(i) a first computing device;
(ii) a second computing device, wherein the second computing device is communicably coupled to the first computing device; and
(b) an executing program,
(i) wherein the executing program is running on the combined computing device; and
(ii) wherein the executing program is adapted to configure a network system.

2. The network system design system of claim 1, wherein the executing program is running on the second computing device.

3. The network system design system of claim 1,
(a) wherein the second computing device is communicably coupled to the first computing device via an internet connection; and
(b) a web server, wherein the executing program comprises the web server.

4. The network system design system of claim 3, wherein the web server is scalable.

5. The network system design system of claim 4, wherein the web server comprises a single system.

6. The network system design system of claim 4, wherein the web server comprises multiple systems, wherein the multiple systems are related by clustering.

7. The network system design system of claim 6, wherein the loads of the multiple systems are balanced via geographic load balancing.

8. The network system design system of claim 1, wherein the web server is scalable.

9. The network system design system of claim 8, wherein the web server comprises a single system.

10. The network system design system of claim 8, wherein the web server comprises multiple systems, wherein the multiple systems are related by clustering.

11. The network system design system of claim 10, wherein the loads of the multiple systems are balanced via geographic load balancing.

12. The network system design system of claim 1, wherein the executing program is adapted to interface with a billing system, wherein the executing program sends information to the billing system upon completion of network system design, whereby billing automation is facilitated.

13. The network system design system of claim 1, wherein the executing program is adapted to show one of multiple views via the first computing device.

14. The network system design system of claim 13, wherein each one view of the multiple views has at least one difference from the other views of the multiple views.

15. The network system design system of claim 14, wherein the possible differences comprise:
(a) different information displayed, wherein the information display formats include textual and graphical representations; and
(b) different access rights to change information.

16. The network system design system of claim 15, wherein the multiple views comprise:
(a) customer view;
(b) salesperson view; and
(c) management view.

17. The network system design system of claim 1, wherein the executing program comprises a database server, the database server being adapted to access data elements related to the network system being configured.

18. The network system design system of claim 17, wherein the data elements comprise available components.

19. The network system design system of claim 17, wherein the data elements further comprise business rules, wherein the business rules define combinations of available components as having an allowability state, wherein the set of possible allowability states comprises:
(a) allowed; and
(b) not allowed.

20. The network system design system of claim 17, wherein the data elements comprise graphic representation data.

21. The network system design system of claim 17, wherein the data elements comprise pricing of components.

22. The network system design system of claim 17, wherein the data elements comprise inventory of components.

23. The network system design system of claim 17, wherein the data elements comprise functionality of components.

24. The network system design system of claim 17, wherein the executing program composes the data elements into a unified front end.

25. The network system design system of claim 19, wherein the executing program composes the data elements into a unified front end.

26. The network system design system of claim 22, wherein the executing program is adapted to calculate lead times based on the inventory of components.

27. The network system design system of claim 20, wherein the graphic representation data comprises bitmaps.

28. The network system design system of claim 1, wherein configuration of the network system comprises software configuration, the software being adapted to operate the network system.

29. The network system design system of claim 1, wherein configuration of the network system comprises security configuration, the security comprising security of the network system.

30. The network system design system of claim 1, wherein configuration of the network system comprises storage configuration, the storage comprising a memory system of at least one memory device, wherein the memory system is adapted to store data for the network system.

31. The network system design system of claim 1, wherein configuration of the network system comprises:
(a) software configuration, the software being adapted to operate the network system;
(b) security configuration, the security comprising security of the network system; and
(c) storage configuration, the storage comprising a memory system of at least one memory device, wherein the memory system is adapted to store data for the network system.

32. The network system design system of claim 31,
(a) wherein the executing program comprises a web server;
(b) wherein the second computing device is communicably coupled to the first computing device via an internet connection; and
(c) wherein the web server is adapted to distribute information via the internet connection.

33. The network system design system of claim 32, wherein the web server comprises a single system.

34. The network system design system of claim 32, wherein the web server comprises multiple systems, wherein the multiple systems are related by clustering.

35. The network system design system of claim 32, wherein the web server comprises multiple systems,
(i) wherein the multiple systems are related by clustering; and
(ii) wherein the loads of the multiple systems are balanced via geographic load balancing.

36. The network system design system of claim 31, wherein the executing program comprises a database server, the database server being adapted to access data elements related to the network system being configured.

37. The network system design system of claim 36, wherein the data elements comprise available components.

38. The network system design system of claim 37, wherein the data elements comprise business rules, wherein the business rules define combinations of available components as having an allowability state, wherein the set of possible allowability states comprises:
(a) allowed; and
(b) not allowed.

39. The network system design system of claim 36, wherein the data elements comprise graphic representation data.

40. The network system design system of claim 36, wherein the data elements comprise pricing of components.

41. The network system design system of claim 36, wherein the data elements comprise inventory of components.

42. The network system design system of claim 36, wherein the data elements comprise functionality of components.

43. A network system design method, comprising:
(a) receiving input;
(b) configuring a network system based on the input,
(i) wherein the network system comprises a set of network components based on:
(1) components included in the network system before the configuring;
(2) components to be added to the network system, according to the input; and
(3) components to be removed from the network system, according to the input; and
(ii) wherein the network system further comprises a set of connectivity relationships among the network components based on:
(1) connectivity relationships included in the network system before the configuring;
(2) connectivity relationships to be added to the network system, according to the input; and
(3) connectivity relationships to be removed from the network system, according to the input.
(b) sending user network specifications based on the network system; and
(c) storing the network system after the configuring.

44. The network system design method of claim 43, further comprising the step of requesting input before receiving input.

45. The network system design method of claim 43, wherein the input comprises:
(a) a selected component; and
(b) a connectivity relationship of the selected component in relation to at least one of the network components.

46. The network system design method of claim 43, wherein the network system further comprises network software based on:
(a) network software included in the network system before the configuring;
(b) network software to be added to the network system, according to the input; and
(c) network software to be removed from the network system, according to the input.

47. The network system design method of claim 43, wherein the network system further comprises network security based on:
(a) network security included in the network system before the configuring;
(b) network security to be added to the network system, according to the input; and
(c) network security to be removed from the network system, according to the input.

48. The network system design method of claim 43, wherein the network system further comprises storage based on:
(a) storage included in the network system before the configuring;
(b) storage to be added to the network system, according to the input; and
(c) storage to be removed from the network system, according to the input.

49. The network system design method of claim 43, wherein the network system further comprises a cluster configuration of network components, the cluster configuration comprising cluster relationships among the network components, the cluster configuration being based on:
(a) cluster relationships included in the network system before the configuring;
(b) cluster relationships to be added to the network system, according to the input; and
(c) cluster relationships to be removed from the network system, according to the input.

50. The network system design method of claim 43, wherein the network system further comprises a geographic location of each network component based on:
(a) geographic location of each component included in the network system before the configuring;
(b) geographic location of each component to be added to the network system, according to the input; and
(c) geographic location of each component to be removed from the network system, according to the input.

51. The network system design method of claim 43, wherein the user network specifications comprise graphical representation of components, the graphical representation of components showing the components configured to compose the network system.

52. The network system design method of claim 43, further comprising:
(a) receiving inventory information;
(b) storing the inventory information after receiving inventory information; and
(c) wherein the user network specifications comprise inventory levels.

53. The network system design method of claim 43, further comprising:
(a) receiving inventory information;
(b) storing the inventory information after receiving inventory information;
(c) calculating estimated network component lead times based on the inventory information; and
(d) wherein the user network specifications comprise the estimated network component lead times.

54. The network system design method of claim 43, further comprising:
(a) receiving inventory information;
(b) storing the inventory information after receiving inventory information;
(c) calculating estimated network system lead time based on the inventory information; and
(d) wherein the user network specifications comprise the estimated network system lead time.

55. The network system design method of claim 43, wherein the user network specifications comprise the network components.

56. The network system design method of claim 43, wherein the user network specifications further comprise the connectivity relationships among the network components.

57. The network system design method of claim 43, wherein the user network specifications further comprise the network software.

58. The network system design method of claim 43, wherein the user network specifications further comprise the network security.

59. The network system design method of claim 43, wherein the user network specifications further comprise the storage.

60. The network system design method of claim 43, wherein the user network specifications further comprise the cluster configuration.

61. The network system design method of claim 43, wherein the user network specifications further comprise the geographic location of each network component.
